(19) United States
(12) Patent Application Publication
(10) Pub. No.: US 2022/0254101 A1
(43) Pub. Date: Aug. 11, 2022

(54) FACE MODEL PARAMETER ESTIMATION DEVICE, FACE MODEL PARAMETER ESTIMATION METHOD, AND FACE MODEL PARAMETER ESTIMATION PROGRAM

(71) Applicant: AISIN CORPORATION, Kariya (JP)

(72) Inventors: Shin OSUGA, Kariya (JP); Shin-Ichi KOJIMA, Nagakute-shi (JP)

(73) Assignee: AISIN CORPORATION, Kariya (JP)

(21) Appl. No.: 17/648,685

(22) Filed: Jan. 24, 2022

(30) Foreign Application Priority Data
Feb. 10, 2021 (JP) 2021-019659

(51) Int. Cl. G06T 17/00; G06T 7/73; G06T 7/50; G06T 19/20

(52) U.S. Cl. CPC G06T 17/00; G06T 7/73; G06T 7/50; G06T 2207/30201; G06T 2219/2016; G06T 2219/2021; G06T 19/20

(57) ABSTRACT

A face model parameter estimation device includes: an image coordinate system coordinate value derivation unit detecting x-coordinate and y-coordinate values in an image coordinate system at a feature point of an organ of a face in an image and estimating a z-coordinate value to derive three-dimensional coordinate values in the image coordinate system; a camera coordinate system coordinate value derivation unit deriving three-dimensional coordinate values in a camera coordinate system from the three-dimensional coordinate values in the image coordinate system; a parameter derivation unit applying the three-dimensional coordinate values in the camera coordinate system to a three-dimensional face shape model to derive a position and posture parameter of the three-dimensional face shape model in the camera coordinate system; and an error estimation unit estimating a position and posture error between the position and posture parameter and a true parameter and a shape deformation parameter.

### CROSS REFERENCE TO RELATED APPLICATIONS

This application is based on and claims priority under 35 U.S.C. § 119 to Japanese Patent Application 2021-019659, filed on Feb. 10, 2021, the entire content of which is incorporated herein by reference.

### TECHNICAL FIELD

This disclosure relates to a face model parameter estimation device, a face model parameter estimation method, and a face model parameter estimation program.

### BACKGROUND DISCUSSION

In the related art, there have been the following techniques as a technique for deriving model parameters in a camera coordinate system of a three-dimensional face shape model by using a face image acquired by capturing an image of a face of a person.

J. M. Saragih, S. Lucey and J. F. Cohn, “Face Alignment through Subspace Constrained Mean-Shifts,” International Conference on Computer Vision (ICCV) 2009 (Reference 1) discloses a technique for estimating parameters by using feature points detected from a face image and a projection error of an image projection point of a vertex of a three-dimensional face shape model.

Further, T. Baltrusaitis, P. Robinson and L.-P. Morency, “3D Constrained Local Model for Rigid and Non-Rigid Facial Tracking,” Conference on Computer Vision and Pattern Recognition (CVPR) 2012 (Reference 2) discloses a technique for estimating parameters by using unevenness information of feature points detected from a face image and feature points acquired from a three-dimensional sensor, and a projection error of an image projection point of a vertex of a three-dimensional face shape model.

Since a shape of a target is unknown when a parameter of a three-dimensional face shape model is estimated, if the parameter is estimated using an average shape, an error occurs in a position and posture parameter related to a position and a posture of the three-dimensional face shape model. Further, in a state in which an error occurs in the parameter related to the position and the posture, an error also occurs in estimation of a shape deformation parameter which is a parameter related to deformation from an average shape.

A need thus exists for a face model parameter estimation device, a face model parameter estimation method, and a face model parameter estimation program which are not susceptible to the drawback mentioned above.

### SUMMARY

A face model parameter estimation device according to a first aspect of this disclosure includes: an image coordinate system coordinate value derivation unit configured to detect an x-coordinate value and a y-coordinate value which are a horizontal coordinate value and a vertical coordinate value in an image coordinate system, respectively, at a feature point of an organ of a face of a person in an image acquired by capturing an image of the face and estimate a z-coordinate value which is a depth coordinate value in the image coordinate system to derive three-dimensional coordinate values in the image coordinate system; a camera coordinate system coordinate value derivation unit configured to derive three-dimensional coordinate values in a camera coordinate system from the three-dimensional coordinate values in the image coordinate system derived by the image coordinate system coordinate value derivation unit; a parameter derivation unit configured to apply the three-dimensional coordinate values in the camera coordinate system derived by the camera coordinate system coordinate value derivation unit to a predetermined three-dimensional face shape model to derive a position and posture parameter of the three-dimensional face shape model in the camera coordinate system; and an error estimation unit configured to estimate both a position and posture error between the position and posture parameter derived by the parameter derivation unit and a true parameter and a shape deformation parameter.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a block diagram showing an example of a configuration in which a face image processing device according to an embodiment is implemented by a computer;

FIG. 2 is an image diagram showing an example of an arrangement of electronic devices of the face image processing device according to the embodiment;

FIG. 3 is an image diagram showing an example of a coordinate system in the face image processing device according to the embodiment;

FIG. 4 is a block diagram showing an example of a configuration in which a device main body of the face image processing device according to the embodiment is functionally classified; and

FIG. 5 is a flowchart showing an example of a flow of processing by a face model parameter estimation program according to the embodiment.

### DETAILED DESCRIPTION

Hereinafter, an example of an embodiment disclosed here will be described with reference to the drawings. The same reference numerals are given to the same or equivalent components and parts in each drawing. Further, dimensional ratios in the drawings are exaggerated for convenience of description and may differ from the actual ratios.

The present embodiment describes an example of a case where a parameter of a three-dimensional face shape model of a person is estimated using a captured image acquired by capturing an image of a head of a person. Further, in the present embodiment, as an example of a parameter of the three-dimensional face shape model of the person, a parameter of a three-dimensional face shape model of an occupant of a vehicle such as an automobile as a moving body is estimated by a face model parameter estimation device.

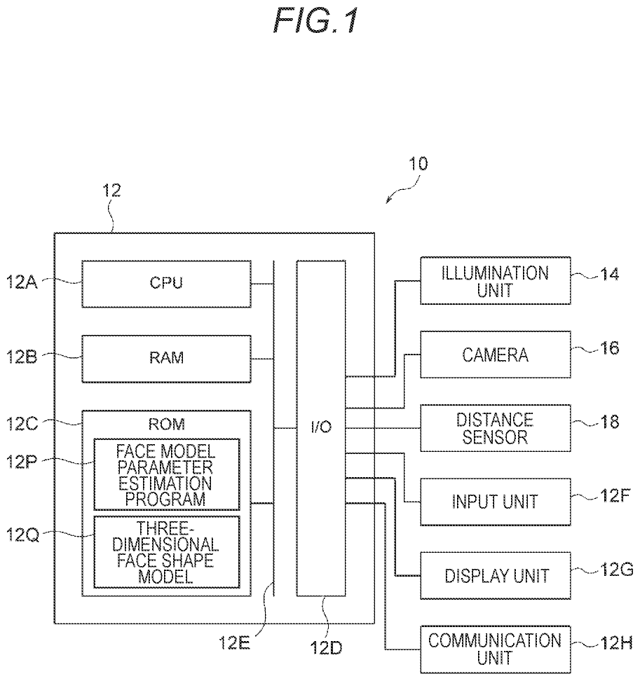

FIG. 1 shows an example of a configuration in which a face model parameter estimation device 10 operating as a face model parameter estimation device according to the disclosed technology is implemented by a computer.

As shown in FIG. 1, the computer operating as the face model parameter estimation device 10 includes a device main body 12 equipped with a central processing unit (CPU) 12A as a processor, a random access memory (RAM) 12B, and a read only memory (ROM) 12C. The ROM 12C includes a face model parameter estimation program 12P for implementing various functions for estimating a parameter of a three-dimensional face shape model. The device main body 12 includes an input/output interface (hereinafter referred to as I/O) 12D, and the CPU 12A, the RAM 12B, the ROM 12C, and the I/O 12D are connected to each other via a bus 12E so as to be able to transmit and receive commands and data. Further, an input unit 12F such as a keyboard and a mouse, a display unit 12G such as a display, and a communication unit 12H for communicating with an external device are connected to the I/O 12D. Further, an illumination unit 14 such as a near-infrared light emitting diode (LED) that illuminates a head of the occupant, a camera 16 that captures an image of the head of the occupant, and a distance sensor 18 that measures a distance to the head of the occupant are connected to the I/O 12D. Although not shown, a nonvolatile memory capable of storing various data can be connected to the I/O 12D.

The device main body 12 operates, as the face model parameter estimation device 10, by reading the face model parameter estimation program 12P from the ROM 12C, expanding the program in the RAM 12B, and executing the face model parameter estimation program 12P being expanded in the RAM 12B by the CPU 12A. The face model parameter estimation program 12P includes a process for realizing various functions for estimating parameters of the three-dimensional face shape model.

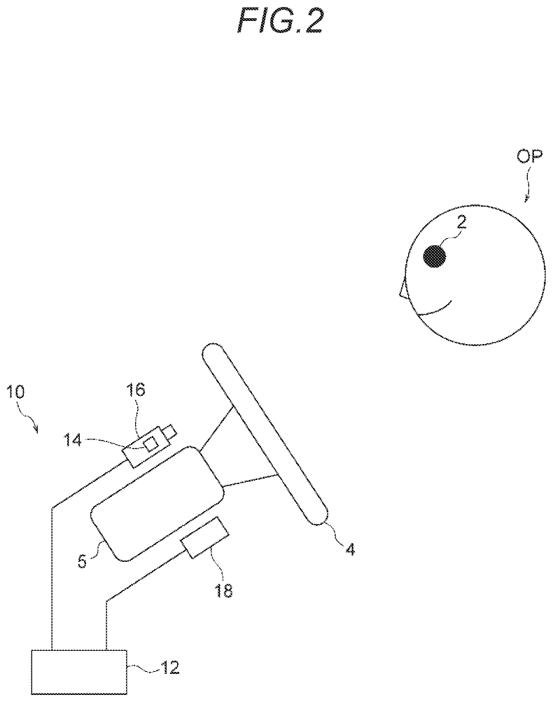

FIG. 2 shows an example of an arrangement of an electronic device mounted on the vehicle as the face model parameter estimation device 10.

As shown in FIG. 2, the vehicle is equipped with the device main body 12 of the face model parameter estimation device 10, the illumination unit 14 for illuminating an occupant OP, the camera 16 for capturing the image of the head of the occupant OP, and the distance sensor 18. In the arrangement example of the present embodiment, a case where the illumination unit 14 and the camera 16 are disposed on an upper portion of a column 5 for holding a steering wheel 4 and the distance sensor 18 is disposed on a lower portion is shown.

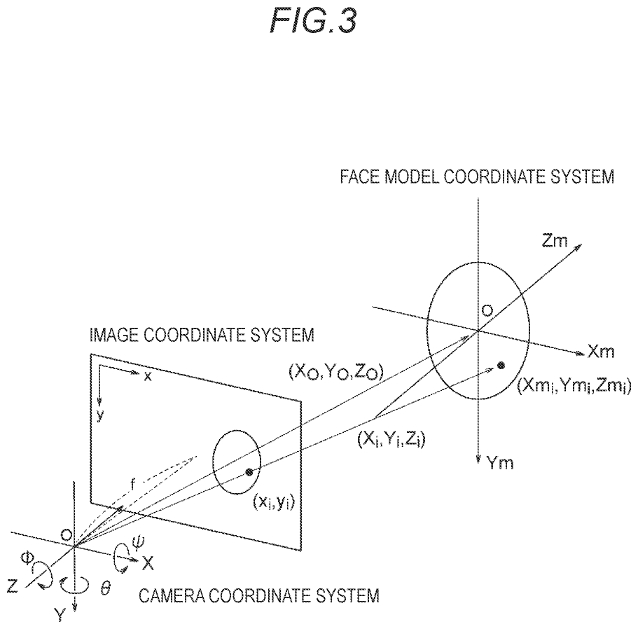

FIG. 3 shows an example of a coordinate system in the face model parameter estimation device 10.

The coordinate system for specifying a position differs depending on how an article as a center is handled. Examples include a coordinate system centered on a camera for capturing an image of a face of a person, a coordinate system centered on a captured image, and a coordinate system centered on a face of a person, for example. In the following description, the coordinate system centered on the camera is referred to as a camera coordinate system, the coordinate system centered on the captured image is referred to as an image coordinate system, and the coordinate system centered on the face is referred to as a face model coordinate system. The example shown in FIG. 3 shows an example of a relationship among the camera coordinate system, the face model coordinate system, and the image coordinate system used in the face model parameter estimation device 10 according to the present embodiment.

In the camera coordinate system, a right side is an X direction, a lower side is a Y direction, and a front side is a Z direction when viewed from the camera 16, and an origin is a point derived by calibration. The camera coordinate system is defined such that directions of an x-axis, a y-axis, and a z-axis coincide with those in the image coordinate system whose origin is the upper left of the image.

The face model coordinate system is a coordinate system for expressing positions of parts such as eyes and a mouth in the face. For example, face image processing generally uses a technique of projecting data onto an image using the data called a three-dimensional face shape model in which a three-dimensional position of a characteristic part of a face such as eyes and a mouth is described, and estimating a position and a posture of the face by combining the positions of the eyes and the mouth. An example of the coordinate system set in the three-dimensional face shape model is the face model coordinate system, and the left side is an Xm direction, the lower side is a Ym direction, and the rear side is a Zm direction when viewed from the face.

An interrelationship between the camera coordinate system and the image coordinate system is predetermined, and coordinate conversion is possible between the camera coordinate system and the image coordinate system. An interrelationship between the camera coordinate system and the face model coordinate system can be specified by using estimation values of the position and the posture of the face.

On the other hand, as shown in FIG. 1, the ROM 12C includes a three-dimensional face shape model 12Q. The three-dimensional face shape model 12Q according to the present embodiment is formed of a linear sum of an average shape and a base, and in the base, an individual difference base (a component that does not change with time) and a facial expression base (a component that changes with time) are separated. That is, the three-dimensional face shape model 12Q according to the present embodiment is expressed by the following Equation (1).

xᵢ=xᵢ^{m}+Eᵢ^{id}p^{id}+Eᵢ^{exp}p^{exp} (1)

Meaning of variables in the above equation (1) is as follows.

i: vertex number (0 to L−1)

L: the number of vertices

xᵢ: i-th vertex coordinates (three-dimensional)

x^{m}ᵢ: i-th vertex coordinate (three-dimensional) of average shape

E^{id}ᵢ: matrix (3×M^{id} dimension) in which M^{id} individual difference base vectors corresponding to the i-th vertex coordinates of the average shape are arranged

p^{id}: parameter vector (M^{id} dimension) of individual difference base

E^{exp}ᵢ: matrix (3×M^{exp} dimension) in which M^{id} facial expression base vectors corresponding to the i-th vertex coordinates of the average shape are arranged

p^{exp}: parameter vector (M^{exp} dimension) of facial expression base

The three-dimensional face shape model 12Q of Equation (1) is subjected to rotation, translation, and scaling to obtain Equation (2) below.

sRxᵢ+t=sR(xᵢ^{m}+Eᵢ^{id}p^{id}+Eᵢ^{exp}p^{exp})+t (2)

In Equation (2), s is a scaling coefficient (one dimension), R is a rotation matrix (3×3 dimensions), and t is a translation vector (three-dimensions). The rotation matrix R is expressed by, for example, a rotation parameter represented by the following Equation (3).

$$R = ( \begin{matrix}cos θ cos ϕ & sin ψ sin θ cos ϕ - cos ψ sin ϕ & cos ψ sin θ cos ϕ + sin ψsinϕ \\ cos θ sin ϕ & sin ψ sin θ s in ϕ + cos ψ cos ϕ & cos ψ sin θ sin ϕ - sin ψcos ϕ \\ - sin θ & sin ψ cos θ & cos ψ cos θ\end{matrix} ) \qquad ( 3 )$$

In Equation (3), ψ, θ, and ϕ are rotation angles around the X-axis, the Y-axis, and the Z-axis in a camera center coordinate system, respectively.

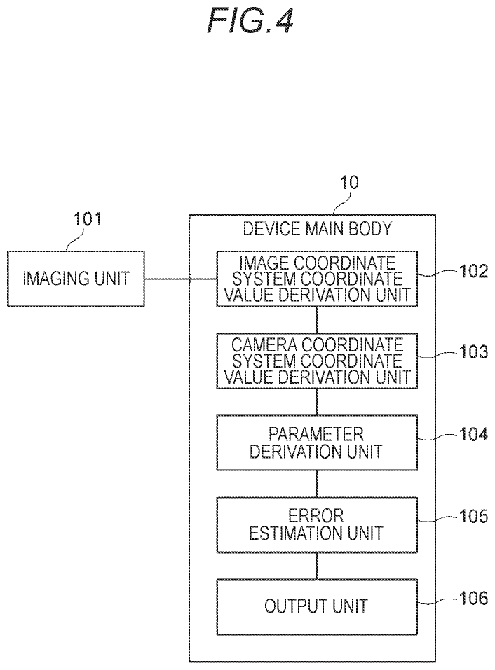

FIG. 4 shows an example of a block configuration in which the device main body 12 of the face model parameter estimation device 10 according to the present embodiment is classified into functional configurations.

As shown in FIG. 4, the face model parameter estimation device 10 includes functional units of an imaging unit 101 such as a camera and the like, an image coordinate system coordinate value derivation unit 102, a camera coordinate system coordinate value derivation unit 103, a parameter derivation unit 104, an error estimation unit 105, and an output unit 106.

The imaging unit 101 is a functional unit that captures the image of a face of a person to acquire a captured image, and outputs the acquired captured image to the image coordinate system coordinate value derivation unit 102. In the present embodiment, the camera 16, which is an example of an imaging device, is used as an example of the imaging unit 101. The camera 16 captures the image of the head of the occupant OP of the vehicle and outputs the captured image. In the present embodiment, textured 3D data obtained by combining an image captured by the camera 16 and distance information output by the distance sensor 18 is output from the imaging unit 101. Although in the present embodiment, a camera that captures an image of a monochrome image is applied as the camera 16, this disclosure is not limited to this, and a camera that captures a color image may be applied as the camera 16.

The image coordinate system coordinate value derivation unit 102 respectively detects an x-coordinate value which is a horizontal coordinate value and a y-coordinate value which is a vertical coordinate value of the image coordinate system at a feature point of the organ of the face of the person in the captured image. The image coordinate system coordinate value derivation unit 102 can use any technique as a technique for extracting feature points from a captured image. For example, the image coordinate system coordinate value derivation unit 102 extracts a feature point from the captured image by a technique described in “Vahid Kazemi and Josephine Sullivan, “One Millisconed Face Alignment with an Ensemble of Regression Trees””.

Further, the image coordinate system coordinate value derivation unit 102 estimates a z-coordinate value which is a depth coordinate value of the image coordinate system. The image coordinate system coordinate value derivation unit 102 derives three-dimensional coordinate values of the image coordinate system by detecting the x-coordinate value and the y-coordinate value described above and estimating the z-coordinate value. The image coordinate system coordinate value derivation unit 102 according to the present embodiment derives the z-coordinate value by estimating the z-coordinate value using deep learning in parallel with the detection of the x-coordinate value and the y-coordinate value.

The camera coordinate system coordinate value derivation unit 103 derives three-dimensional coordinate values in the camera coordinate system from the three-dimensional coordinate values of the image coordinate system derived by the image coordinate system coordinate value derivation unit 102.

The parameter derivation unit 104 apply the three-dimensional coordinate values in the camera coordinate system derived by the camera coordinate system coordinate value derivation unit 103 to the three-dimensional face shape model 12Q to derive a position and posture parameter in the camera coordinate system of the three-dimensional face shape model 12Q. For example, the parameter derivation unit 104 derives a translation parameter, a rotation parameter, and a scaling parameter as the position and posture parameters.

The error estimation unit 105 estimates a position and posture error, which is an error between the position and posture parameter derived by the parameter derivation unit 104 and a true parameter, and a shape deformation parameter at a time. Specifically, the error estimation unit 105 estimates a translation parameter error, a rotation parameter error, and a scaling parameter error, which are errors respectively between the translation parameter, the rotation parameter, and the scaling parameter derived by the parameter derivation unit 104 and the true parameter, and the shape deformation parameter together. The shape deformation parameter includes a parameter vector p^{id} of the individual difference base and a parameter vector p^{exp} of the facial expression base.

The output unit 106 outputs information indicating the position and posture parameter and the shape deformation parameter in the camera coordinate system of the three-dimensional face shape model 12Q of the person derived by the parameter derivation unit 104. The output unit 106 outputs information indicating the position and posture error estimated by the error estimation unit 105.

Next, an operation of the face model parameter estimation device 10 that estimates the parameter of the three-dimensional face shape model 12Q will be described. In the present embodiment, the face model parameter estimation device 10 is operated by the device main body 12 of the computer.

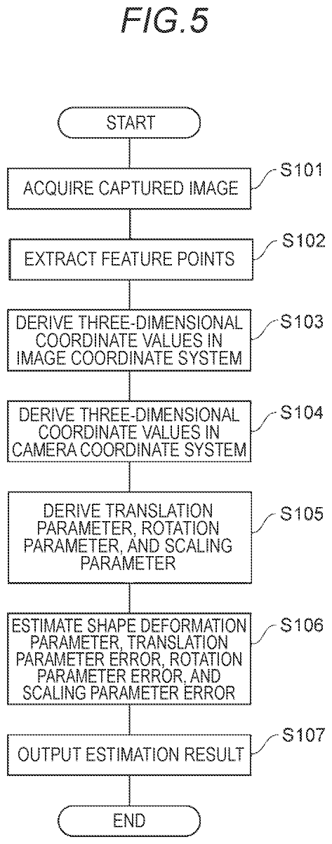

FIG. 5 shows an example of a flow of processing by the face model parameter estimation program 12P in the face model parameter estimation device 10 implemented by a computer. The device main body 12 reads the face model parameter estimation program 12P from the ROM 12C, expands the program in the RAM 12B, and executes the face model parameter estimation program 12P being expanded in the RAM 12B by the CPU 12A.

First, the CPU 12A executes processing of acquiring a captured image captured by the camera 16 (step S101). Processing of step S101 is an example of an operation of acquiring the captured image output from the imaging unit 101 shown in FIG. 4.

Subsequent to step S101, the CPU 12A detects feature points of a plurality of organs of the face from the acquired captured image (step S102). Although in the present embodiment, two organs of the eyes and the mouth are applied as the plurality of organs, the disclosure is not limited to this. In addition to these organs, other organs such as the nose and ears may be included, and a plurality of combinations of the above organs may be applied. In the present embodiment, a feature point is extracted from the captured image by a technique described in “Vahid Kazemi and Josephine Sullivan, “One Millisecond Face Alignment with an Ensemble of Regression Trees””.

Subsequent to step S102, the CPU 12A derives the three-dimensional coordinate values of the feature point of each organ in the image coordinate system by detecting the x-coordinate value and the y-coordinate value of the detected feature point of each organ in the image coordinate system, and estimating the z-coordinate value in the image coordinate system (step S103). In the present embodiment, the derivation of the three-dimensional coordinate values in the image coordinate system is performed by using the technique described in “Y. Sun, X. Wang and X. Tang, “Deep Convolutional Network Cascade for Facial Point Detection,” Conference on Computer Vision and Pattern Recognition (CVPR) 2013.”. In the technique, the x-coordinate value and the y-coordinate value of each feature point are detected by deep learning, and the z-coordinate value can be estimated by adding the z-coordinate value to learning data. Since the technique for deriving the three-dimensional coordinate values in the image coordinate system is also a widely and generally practiced technique, further description thereof is omitted here.

Subsequent to step S103, the CPU 12A derives three-dimensional coordinate values in the camera coordinate system from the three-dimensional coordinate values in the image coordinate system acquired in the processing of step S103 (step S104). In the present embodiment, the three-dimensional coordinate values in the camera coordinate system are derived by calculation using the following Equations (4) to (6).

$${Z}_{k}^{o} = ( \frac{{Z}_{k}}{f} + 1 ) d \qquad ( 4 )$$

$${X}_{k}^{o} = ( {x}_{k} - {x}_{c} ) \frac{{Z}_{k}}{f} \qquad ( 5 )$$

$${Y}_{k}^{o} = ( {y}_{k} - {y}_{c} ) \frac{{Z}_{k}}{f} \qquad ( 6 )$$

Meaning of variables in the above equations (4) to (6) is as follows.

k: observation point number (0 to N−1)

N: the total number of observation points

X^{o}ₖ, Y^{o}ₖ, Z^{o}ₖ: xyz coordinates of the observation point in the camera coordinate system

xₖ, yₖ, zₖ: xyz coordinates of the observation point in the image coordinate system

x_{c}, y_{c}: image center

f: focal length of pixel unit

d: temporary distance to face

Subsequent to step S104, the CPU 12A applies the three-dimensional coordinate values of the camera coordinate system obtained in the processing of step S104 to the three-dimensional face shape model 12Q. Then, the CPU 12A derives the translation parameter, the rotation parameter, and the scaling parameter of the three-dimensional face shape model 12Q (step S105).

In the present embodiment, an evaluation function g represented by the following Equation (7) is used to derive a translation vector t as the translation parameter, a rotation matrix R as the rotation parameter, and a scaling coefficient s as the scaling parameter.

$$g = {\sum }_{k = 0}^{N - 1} {‖ {x}_{k}^{o} - ( s + t ) ‖}^{2} = {\sum }_{k = 0}^{N - 1} {‖ {x}_{k}^{o} - ( s R ( + {p}^{id} + {p}^{exp} ) + t ‖}^{2} \qquad ( 7 )$$

In the above equation (7), \acute{k} is a vertex number of the face shape model corresponding to the k-th observation point. In addition, x_{\acute{k}} is a vertex coordinate of the face shape model corresponding to the k-th observation point.

In Equation (7), s, R, and t can be obtained by an algorithm (hereinafter, referred to as “algorithm of Umeyama”) disclosed in “S. Umeyama, “Least-squares estimation of transformation parameters between two point patterns”, IEEE Trans. PAMI, vol. 13, no. 4, April 1991.”, as p^{id}=p^{exp}=0.

When the scaling coefficient s, the rotation matrix R, and the translation vector t are obtained, the parameter vector p^{id} of the individual difference base and the parameter vector p^{exp} of the facial expression base are obtained as a least square solution of simultaneous equations of the following Equation (8).

$${s}^{- 1} {R}^{- 1} ( {x}_{k}^{o} - t ) - = {p}^{id} + {p}^{exp} = ( \begin{matrix} & \end{matrix} ) ( \begin{matrix}{p}^{id} \\ {p}^{exp}\end{matrix} ) \qquad ( 8 )$$

The least square solution of Equation (8) is the following Equation (9). In Equation (9), T represents a transpose.

$$( \begin{matrix}{p}^{id} \\ {p}^{exp}\end{matrix} ) = {( {( \begin{matrix} & \end{matrix} )}^{T} ( \begin{matrix} & \end{matrix} ) )}^{- 1} {( \begin{matrix} & \end{matrix} )}^{T} ( {s}^{- 1} {R}^{- 1} ( {x}_{k}^{o} - t ) - ) \qquad ( 9 )$$

At the time of obtaining the scaling coefficient s, the rotation matrix R, and the translation vector t, since the shape of the target is unknown, when s, R, and t are obtained in the average shape with p^{id} p^{exp}=0, all of the estimated s, R, and t include errors. When p^{id} and p^{exp} are obtained by the above Equation (8), since simultaneous equations are solved using s, R, and t including errors, p^{id} and p^{exp} also include errors. When the estimation of s, R, and t and the estimation of p^{id} and p^{exp} are alternately performed, a value of each parameter does not always converge to a correct value, but diverges in some cases.

Therefore, the face model parameter estimation device 10 according to the present embodiment estimates the scaling coefficient s, the rotation matrix R, and the translation vector t, and then estimates the scaling parameter error p^{s}, the rotation parameter error p^{r}, the translation parameter error p^{t}, the parameter vector p^{id} of the individual difference base, and the parameter vector p^{exp} of the facial expression base at a time.

Subsequent to step S105, the CPU 12A estimates the shape deformation parameter, the translation parameter error, the rotation parameter error, and the scaling parameter error at a time (step S106). As described above, the shape deformation parameter includes the parameter vector p^{id} of the individual difference base and the parameter vector p^{exp} of the facial expression base. Specifically, the CPU 12A calculates the following Equation (10) in step S106.

$${s}^{- 1} {R}^{- 1} ( {x}_{k}^{o} - t ) - = {p}^{id} + {p}^{exp} + {p}^{r} + {p}^{t} + {p}^{s} = ( \begin{matrix} & & & & \end{matrix} ) ( \begin{matrix}{p}^{id} \\ {p}^{exp} \\ {p}^{r} \\ {p}^{t} \\ {p}^{s}\end{matrix} ) \qquad ( 10 )$$

In the above equation (10), E_{\acute{k}}^{r}, E_{\acute{k}}^{t}, E_{\acute{k}}^{s} is a matrix (3×3 dimensions) in which three base vectors for calculating a rotation parameter error, a translation parameter error, and a scaling parameter error corresponding to the i-th vertex coordinates of the average shape are arranged. p^{r}, p^{s} and p^{s} are parameter vectors of the rotation parameter error, the translation parameter error, and the scaling parameter error, respectively. The parameter vectors of the rotation parameter error and the translation parameter error are three-dimensional, and the parameter vector of the scaling parameter error is one-dimensional.

A configuration of a matrix in which three base vectors of the rotation parameter error are arranged will be described. The matrix is formed by calculating the following equation (11) at each vertex.

$$= ( \begin{matrix} & {E}_{k}^{{r}_{θ}} & \end{matrix} ) \\ = ( \begin{matrix} \\ \\ \end{matrix} ) - ( \begin{matrix}1 & 0 & 0 \\ 0 & cos Δ ψ & - sin Δ ψ \\ 0 & sin Δ ψ & cos Δ ψ\end{matrix} ) ( \begin{matrix} \\ \\ \end{matrix} ) = ( \begin{matrix}0 \\ - cos Δ ψ + sin Δψ \\ - sin Δ ψ - cos Δψ\end{matrix} ) \\ {E}_{k}^{{r}_{θ}} = \\ ( \begin{matrix} \\ \\ \end{matrix} ) - ( \begin{matrix}cos Δ θ & 0 & sin Δ θ \\ 0 & 1 & 0 \\ - sin Δ θ & 0 & cos Δ θ\end{matrix} ) ( \begin{matrix} \\ \\ \end{matrix} ) = ( \begin{matrix}- cos Δ θ - sin Δθ \\ 0 \\ + sin Δθ - cos Δ θ\end{matrix} ) \\ = ( \begin{matrix} \\ \\ \end{matrix} ) - ( \begin{matrix}cos Δ ϕ & - sin Δ ϕ & 0 \\ sin Δ ϕ & cos Δ ϕ & 0 \\ 0 & 0 & 1\end{matrix} ) ( \begin{matrix} \\ \\ \end{matrix} ) = ( \begin{matrix}- cos Δ θ + sin Δ θ \\ - sin Δθ - cos Δ θ \\ 0\end{matrix} ) \qquad ( 11 )$$

In Equation (11), Δψ, Δθ, and Δϕ are minute angles of about α=1/1000 to 1/100 [rad]. After the equation (10) is solved, a value obtained by multiplying p^{r} by α⁻¹ is a rotation parameter error.

Next, a configuration of a matrix in which three base vectors of translation parameter errors are arranged will be described. For the matrix, the following equation (12) is used for all vertices.

$$= ( \begin{matrix}1 & 0 & 0 \\ 0 & 1 & 0 \\ 0 & 0 & 1\end{matrix} ) \qquad ( 12 )$$

Next, a configuration of a matrix in which three base vectors of scaling parameter errors are arranged will be described. For the matrix, the following equation (13) is used for all vertices.

$$= ( \begin{matrix} \\ \\ \end{matrix} ) \qquad ( 13 )$$

A least square solution of Equation (10) is the following Equation (14). T in E^{T} represents a transpose.

$$= ( \begin{matrix} & & & & \end{matrix} ) \\ ( \begin{matrix}{p}^{id} \\ {p}^{exp} \\ {p}^{r} \\ {p}^{t} \\ {p}^{s}\end{matrix} ) = {( )}^{- 1} ( {s}^{- 1} {R}^{- 1} ( {x}_{k}^{o} - t ) - ) \qquad ( 14 )$$

P^{id} and p^{exp} in Equation (14) are accurate individual difference parameter and expression parameter to be obtained. Accurate translation parameters, rotation parameters, and scaling parameters are expressed by the following equation (15).

First, the rotation parameter will be described. As for the rotation parameter, ψ, θ, and ϕ can be obtained by first obtaining the rotation matrix R using the algorithm of Umeyama and then comparing the rotation matrix R with Equation (3). The provisional values of ψ, θ, and ϕ thus obtained are defined as ψₜₘₚ, θₜₘₚ, and ϕₜₘₚ, respectively. In a case where p^{r} obtained by Equation (14) is expressed as p^{r}=(\acute{ψ} \acute{θ} \acute{ϕ})^{T}, the accurate rotation parameters ψ, θ, and ϕ are expressed by the following equation (15).

ψ=ψₜₘₚ+α⁻¹\acute{ψ}

θ=θₜₘₚ+α⁻¹\acute{θ}

ϕ=ϕₜₘₚ+α⁻¹\acute{ϕ} (15)

Next, the translation parameter will be described. Provisional values of the translation parameters obtained by the algorithm of Umeyama are t_{x_tmp}, t_{y_tmp}, and t_{z_tmp}. In a case where pₜ obtained by Equation (14) is expressed as p^{t}=(\acute{t}ₓ \acute{t}_{y} \acute{t}_{z})^{T}, accurate translation parameters tₓ, t_{y}, and t_{z} are expressed by the following equation (16).

tₓ=t_{x_tmp}+\acute{t}ₓ

t_{y}=t_{y_tmp}+\acute{t}_{y}

t_{z}=t_{z_tmp}+\acute{t}_{z} (16)

Next, the scaling parameter will be described. A provisional value of the translation parameters obtained by the algorithm of Umeyama is sₜₘₚ. In a case where pₛ obtained by Equation (14) is expressed as p^{s}=ś, an accurate scaling parameter s is expressed by the following equation (17).

s=sₜₘₚ+ś (17)

Subsequent to step S106, the CPU 12A outputs an estimation result (step S107). Estimation values of various parameters output by the processing of step S107 are used for estimating the position and the posture of the occupant of the vehicle, tracking the face image, and the like.

As described above, according to the face parameter estimation device according to the present embodiment, an x-coordinate value which is a horizontal coordinate value and a y-coordinate value which is a vertical coordinate value in an image coordinate system is respectively detected at a feature point of an organ of a face of the person in an image acquired by capturing an image of the face, and a z-coordinate value which is a depth coordinate value in the image coordinate system is estimated so as to derive three-dimensional coordinate values in the image coordinate system and derive a three-dimensional coordinate value of a camera coordinate system from the derived three-dimensional coordinate value of the image coordinate system. Then, according to the face parameter estimation device of the present embodiment, the derived three-dimensional coordinate values of the camera coordinate system are applied to a predetermined three-dimensional face shape model to derive a position and posture parameter of the three-dimensional face shape model in the camera coordinate system, and the shape deformation parameter and the position and posture error are estimated at a time. The face parameter estimation device of the present embodiment can estimate an individual difference parameter and an expression parameter of the three-dimensional face shape model with high accuracy and more accurately estimate the position and posture parameter by estimating the shape deformation parameter and the position and posture error at a time.

Various processors other than the CPU may execute a face parameter estimation processing, which is executed by the CPU reading the software (program) in the above embodiment. In this case, examples of the processor include a programmable logic device (PLD) whose circuit configuration can be changed after manufacturing such as a field-programmable gate array (FPGA), a dedicated electric circuit such as an application specific integrated circuit (ASIC) that is a processor having a circuit configuration specially designed to execute specific processing, or the like. Further, the face parameter estimation processing may be executed by one of these various processors, or may be executed by a combination of two or more processors of the same type or different types (for example, a combination of a plurality of FPGAs or a combination of a CPU and an FPGA). Further, a hardware structure of these various processors is, more specifically, an electric circuit in which circuit elements such as semiconductor elements are combined.

Further, although in each of the above embodiments, a mode is described in which a program of the face parameter estimation processing is stored (installed) in a ROM in advance, the present disclosure is not limited thereto. The program may be provided in a form recorded in a non-transitory recording medium such as a compact disk read only memory (CD-ROM), a digital versatile disk read only memory (DVD-ROM), and a universal serial bus (USB) memory. Further, the program may be downloaded from an external apparatus via a network.

A face model parameter estimation device according to a first aspect of this disclosure includes: an image coordinate system coordinate value derivation unit configured to detect an x-coordinate value and a y-coordinate value which are a horizontal coordinate value and a vertical coordinate value in an image coordinate system, respectively, at a feature point of an organ of a face of a person in an image acquired by capturing an image of the face and estimate a z-coordinate value which is a depth coordinate value in the image coordinate system to derive three-dimensional coordinate values in the image coordinate system; a camera coordinate system coordinate value derivation unit configured to derive three-dimensional coordinate values in a camera coordinate system from the three-dimensional coordinate values in the image coordinate system derived by the image coordinate system coordinate value derivation unit; a parameter derivation unit configured to apply the three-dimensional coordinate values in the camera coordinate system derived by the camera coordinate system coordinate value derivation unit to a predetermined three-dimensional face shape model to derive a position and posture parameter of the three-dimensional face shape model in the camera coordinate system; and an error estimation unit configured to estimate both a position and posture error between the position and posture parameter derived by the parameter derivation unit and a true parameter and a shape deformation parameter.

A face model parameter estimation device according to a second aspect is the face model parameter estimation device according to the first aspect, in which the position and posture parameter includes a translation parameter, a rotation parameter, and a scaling parameter of the three-dimensional face shape model in the camera coordinate system.

A face model parameter estimation device according to a third aspect is the face model parameter estimation device according to the second aspect, in which the position and posture error includes a translation parameter error, a rotation parameter error, and a scaling parameter error which are errors between the derived translation parameter, rotation parameter, and scaling parameter and respective true parameters.

A face model parameter estimation device according to a fourth aspect is the face model parameter estimation device according to any one of the first to third aspects, in which the three-dimensional face shape model is configured by a linear sum of an average shape and a base.

A face model parameter estimation device according to a fifth aspect is the face model parameter estimation device according to the fourth aspect, in which, in the base, an individual difference base, which is a component that does not change with time, and a facial expression base, which is a component that changes with time, are separated.

A face model parameter estimation device according to a sixth aspect is the face model parameter estimation device according to the fifth aspect, in which the shape deformation parameter includes a parameter of the individual difference base and a parameter of the facial expression base.

A face model parameter estimation method according to a seventh aspect of this disclosure is executed by a computer and includes: detecting an x-coordinate value and a y-coordinate value which are a horizontal coordinate value and a vertical coordinate value in an image coordinate system, respectively, at a feature point of an organ of a face of a person in an image acquired by capturing an image of the face and estimating a z-coordinate value which is a depth coordinate value in the image coordinate system to derive three-dimensional coordinate values in the image coordinate system; deriving three-dimensional coordinate values in a camera coordinate system from the derived three-dimensional coordinate values in the image coordinate system; applying the derived three-dimensional coordinate values in the camera coordinate system to a predetermined three-dimensional face shape model to derive a position and posture parameter of the three-dimensional face shape model in the camera coordinate system; and estimating both a position and posture error between the derived position and posture parameter and a true parameter and a shape deformation parameter.

A face model parameter estimation program according to an eighth aspect of this disclosure causes a computer to execute: detecting an x-coordinate value and a y-coordinate value which are a horizontal coordinate value and a vertical coordinate value in an image coordinate system, respectively, at a feature point of an organ of a face of a person in an image acquired by capturing an image of the face and estimating a z-coordinate value which is a depth coordinate value in the image coordinate system to derive three-dimensional coordinate values in the image coordinate system; deriving three-dimensional coordinate values in a camera coordinate system from the derived three-dimensional coordinate values in the image coordinate system; applying the derived three-dimensional coordinate values in the camera coordinate system to a predetermined three-dimensional face shape model to derive a position and posture parameter of the three-dimensional face shape model in the camera coordinate system; and estimating both a position and posture error between the derived position and posture parameter and a true parameter and a shape deformation parameter.

According to the present disclosure, it is possible to provide the face model parameter estimation device, the face model parameter estimation method and the face model parameter estimation program capable of accurately estimating a parameter of a three-dimensional face shape model by estimating the position and posture parameter related to the position and the posture and the shape deformation parameter at a time.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A face model parameter estimation device comprising:
an image coordinate system coordinate value derivation unit configured to detect an x-coordinate value and a y-coordinate value which are a horizontal coordinate value and a vertical coordinate value in an image coordinate system, respectively, at a feature point of an organ of a face of a person in an image acquired by capturing an image of the face and estimate a z-coordinate value which is a depth coordinate value in the image coordinate system to derive three-dimensional coordinate values in the image coordinate system;
a camera coordinate system coordinate value derivation unit configured to derive three-dimensional coordinate values in a camera coordinate system from the three-dimensional coordinate values in the image coordinate system derived by the image coordinate system coordinate value derivation unit;
a parameter derivation unit configured to apply the three-dimensional coordinate values in the camera coordinate system derived by the camera coordinate system coordinate value derivation unit to a predetermined three-dimensional face shape model to derive a position and posture parameter of the three-dimensional face shape model in the camera coordinate system; and
an error estimation unit configured to estimate both a position and posture error between the position and posture parameter derived by the parameter derivation unit and a true parameter and a shape deformation parameter.

2. The face model parameter estimation device according to claim 1, wherein the position and posture parameter includes a translation parameter, a rotation parameter, and a scaling parameter of the three-dimensional face shape model in the camera coordinate system.

3. The face model parameter estimation device according to claim 2, wherein the position and posture error includes a translation parameter error, a rotation parameter error, and a scaling parameter error which are errors between the derived translation parameter, rotation parameter, and scaling parameter and respective true parameters.

4. The face model parameter estimation device according to claim 1, wherein the three-dimensional face shape model is configured by a linear sum of an average shape and a base.

5. The face model parameter estimation device according to claim 4, wherein, in the base, an individual difference base, which is a component that does not change with time, and a facial expression base, which is a component that changes with time, are separated.

6. The face model parameter estimation device according to claim 5, wherein the shape deformation parameter includes a parameter of the individual difference base and a parameter of the facial expression base.

7. A face model parameter estimation method executed by a computer, the method comprising:
detecting an x-coordinate value and a y-coordinate value which are a horizontal coordinate value and a vertical coordinate value in an image coordinate system, respectively, at a feature point of an organ of a face of a person in an image acquired by capturing an image of the face and estimating a z-coordinate value which is a depth coordinate value in the image coordinate system to derive three-dimensional coordinate values in the image coordinate system;
deriving three-dimensional coordinate values in a camera coordinate system from the derived three-dimensional coordinate values in the image coordinate system;
applying the derived three-dimensional coordinate values in the camera coordinate system to a predetermined three-dimensional face shape model to derive a position and posture parameter of the three-dimensional face shape model in the camera coordinate system; and
estimating both a position and posture error between the derived position and posture parameter and a true parameter and a shape deformation parameter.

8. A face model parameter estimation program which causes a computer to execute:
detecting an x-coordinate value and a y-coordinate value which are a horizontal coordinate value and a vertical coordinate value in an image coordinate system, respectively, at a feature point of an organ of a face of a person in an image acquired by capturing an image of the face and estimating a z-coordinate value which is a depth coordinate value in the image coordinate system to derive three-dimensional coordinate values in the image coordinate system;
deriving three-dimensional coordinate values in a camera coordinate system from the derived three-dimensional coordinate values in the image coordinate system;
applying the derived three-dimensional coordinate values in the camera coordinate system to a predetermined three-dimensional face shape model to derive a position and posture parameter of the three-dimensional face shape model in the camera coordinate system; and
estimating both a position and posture error between the derived position and posture parameter and a true parameter and a shape deformation parameter.
